(19) United States
(12) Patent Application Publication
(10) Pub. No.: US 2007/0285519 A1
(43) Pub. Date: Dec. 13, 2007

(54) Method For Transferring Image Signals And System Using The Method

(75) Inventors: Jung Keun Ahn, Gyeonggi-do (KR); Sung Nam Kang, Seoul (KR)

Correspondence Address: MCCORMICK, PAULDING & HUBER LLP, CITY PLACE II, 185 ASYLUM STREET, HARTFORD, CT, 06103, US

(73) Assignee: UDP CO., LTD., Seoul (KR)

(21) Appl. No.: 11/577,532

(22) PCT Filed: Sep. 15, 2005
(86) PCT No.: PCT/KR05/03070

§ 371 Date: Apr. 19, 2007

(30) Foreign Application Priority Data
Oct. 26, 2004 (KR) 10-2004-0085879

(51) Int. Cl. H04N 5/228

(52) U.S. Cl. 348/208.6; 348/E05.031

(57) ABSTRACT

The present invention relates to an image signal transmission method in a network camera system, and more particularly, to a network camera system and an image signal transmission method in which a low resolution image formed by down-scaling a high resolution image photographed by a high resolution camera is displayed via a display means of a DVR system, and the high resolution image is compressed to be stored in a memory means of the DVR system, thereby preventing overload on the system that may occur due to compressing, transmitting, or decompressing a plurality of high resolution image signals. The network camera system including: a high resolution image photographing unit photographing an object to generate a high resolution image signal; an A/D converter converting the high resolution image signal into a digital image signal; an image signal compression unit receiving the digital image signals from the A/D conversion unit and generating a first image signal by compressing the digital image signal in high resolution; a network interface unit connected to a predetermined network cable, for transmitting the first image signal to a predetermined DVR system connected by the network cable; a down-scaling unit receiving the digital image signal from the A/D conversion unit and generating a second image signal by down-scaling the digital image signal; an image signal encoding unit converting the second image signal into an analog signal to be encoded to a second analog image signal; and an interface unit transmitting the first image signal and the second analog image signal to the DVR system.

### TECHNICAL FIELD

The present invention relates to an image signal transmission method in a network camera system, and more particularly, to a network camera system and an image signal transmission method in which a low resolution image formed by down-scaling a high resolution image photographed by a high resolution camera is displayed via a display means of a DVR system, and the high resolution image is compressed to be stored in a memory means of the DVR system, thereby preventing overload on the system that may occur due to compressing, transmitting, or decompressing a plurality of high resolution image signals.

### BACKGROUND ART

Digital Video Recorders (DVRs), generally used in the security field, are based on digital image compression technology. DVRs are distinguishable from conventional analog type storage devices (VCRs), since DVRs can digitalize an inputted image to compress and store to a hard disk.

DVRs are different from conventional analog types in that maintenance costs do not arise from periodic changing and storing of video tapes. In addition, rapid search is possible while an unusual situation occur high picture quality can be acquired, and an image can be received in real time at a long distance via telephone line or Internet, thereby immediately recognizing an unusual situation and actively dealing with the situation. Thanks to the described merits, DVRs are superior in use and function when compared with conventional analog type VCRs.

DVRs are generally used in checking security conditions of the inside and outside of buildings, parking lots, or banks by installing a plurality of cameras in areas requiring security. The use of DVRs is similar to general closed-circuit televisions (CCTVs). However, there is a great difference between DVRs and CCTVs in operational method. Also, in a CCTV, an image captured by a monitoring camera is recorded on a video tape and read by a VCR. In a DVR, an image data inputted from an analog monitoring camera is converted into a high resolution digital image and stored on a hard disk.

Also, since, a high resolution camera capable of producing a high resolution image is currently applied to a DVR system, the applications are gradually increasing. An image photographed according to a conventional NTSC/PAL standard signal is formed of approximately three hundred to four hundred thousand pixels, but an image photographed by a high resolution camera acquiring an image by a high resolution CCD/CMOS device is formed from a basic eight hundred thousand pixels to a high resolution of one million and five hundred thousand pixels.

The described high resolution image has several merits due to clarity in capturing a photographed object but has demerits in which overload may occur on networks connecting at least one high resolution camera to a DVR in transmitting the high resolution image to the DVR, also a load on the DVR receiving and processing the image from the high resolution camera via network is greatly increased. Since high resolution image signals compressed and transmitted by a plurality of high resolution network cameras have a large data size, it is difficult to receive a photographed image from the DVR in real time due to a limit of network transmission bandwidth. Also, in order to decompress the plurality of high resolution image signals transmitted from the DVR in real time and convert the high resolution image signals into analog signals to display, a highly powerful processor and a large amount of high quality memory for the DVR is required.

### DISCLOSURE OF INVENTION

### Technical Goals

The present invention provides a network camera system and an image transmission method in which a low resolution image signal formed by down-scaling a high resolution image signal captured by a high resolution camera to low resolution and is transmitted to a DVR system along with the high resolution image signal, and the DVR system stores the high resolution image signal in a predetermined memory and displays the low resolution image signal in real time, thereby acquiring a high resolution image without overloading the system and network.

The present invention also provides a network camera system and an image transmission method in which, in a process of compressing a high resolution image signal photographed by a high resolution camera, the high resolution image signal is compressed in two ways, a high resolution storage image signal and a low resolution display image signal, and both are transmitted to a DVR system, the DVR system then stores the high resolution storage image signal in a predetermined memory and displays the low resolution display image signal in real time, thereby more efficiently acquiring a high resolution image without overloading the system and network.

The present invention also provides a network camera system and an image transmission method in which, in the case a user recognizes an unusual situation while displaying a low resolution image via a DVR system in real time, a high resolution image that contains the image including the unusual situation may be searched from a memory means of the DVR system and viewed, thereby making it possible to efficiently search a high resolution image.

### TECHNICAL SOLUTIONS

According to an aspect of the present invention, there is provided a network camera system including: a high resolution image photographing unit photographing an object generating a high resolution image signal; an A/D converter converting the high resolution image signal into a digital image signal; an image signal compression unit receiving the digital image signals from the A/D conversion unit and generating a first image signal by compressing, into a high resolution, the digital image signal; a network interface unit connected to a predetermined network cable, for transmitting the first image signal to a predetermined DVR system connected by the network cable; a down-scaling unit receiving the digital image signal from the A/D conversion unit and generating a second image signal by down-scaling the digital image signal; an image signal encoding unit converting the second image signal into an analog signal to be encoded to a second analog image signal; and an interface unit transmitting the first image signal and the second analog image signal to the DVR system.

According to another aspect of the present invention, there is provided a network camera system including: a high resolution image photographing unit photographing an object generating a high resolution image signal; an A/D converter converting the high resolution image signal into a digital image signal; an image signal capture unit generating a display image signal and a storage image signal by capturing the digital image signal; an image signal compression unit generating a compressed display image signal by compressing the display image signal by using a first compression method and generating a compressed storage image signal by compressing the storage image signal by using a second compression method; and a network interface unit connected to a predetermined network cable, for transmitting the compressed display image signal and the compressed storage image signal to a predetermined DVR system connected by the network cable. Since the second compression method is for producing high resolution quality and the first compression method is for producing low resolution quality, a data size of the compressed storage image signal is larger than the compressed display image signal.

### BRIEF DESCRIPTION OF DRAWINGS

FIG. 1 is a network configuration diagram illustrating the entire configuration of a DVR system including a network camera system of the present invention;

FIG. 2 is a block diagram illustrating a configuration of a network camera system according to an embodiment of the present invention;

FIG. 3 is a diagram illustrating a configuration of a DVR system connected to the network camera system of the present invention via network;

FIG. 4 is a flowchart illustrating an image signal transmission method of the network camera according to an embodiment of the present invention;

FIG. 5 is a block diagram illustrating a configuration of a network camera system according to another embodiment of the present invention;

FIG. 6 is a flowchart illustrating an image signal transmission method of the network camera according to another embodiment of the present invention; and

FIG. 7 is an inner block diagram of a general use computer apparatus capable of being applied to perform the image signal transmission method of the network camera according to the present invention.

### BEST MODE FOR CARRYING OUT THE INVENTION

Hereinafter, the embodiments of the present invention will be described in detail with reference to the attached drawings.

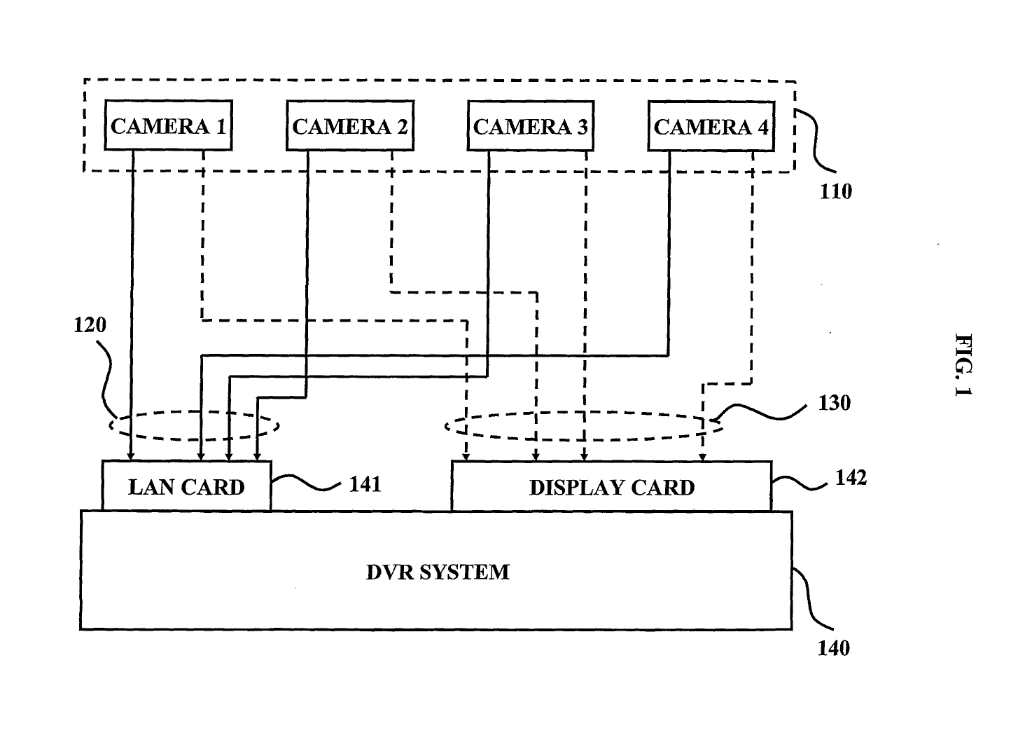

FIG. 1 is a network configuration diagram illustrating the entire configuration of a DVR system including a network camera system of the present invention.

The network camera system of the present invention includes at least one camera, each camera installed at its own respective locations to photograph an object. A DVR system 140 receives an image signal inputted from a network camera system 110 to display or store. Network cables 120 or coaxial cables 130 are intermediates transmitting the image signal between the network camera system 110 and the DVR system 140.

At least one high resolution camera included in the network camera system 110 indicates a camera which supports high resolution image photographing and capable of photographing, with more than eight hundred thousand pixels, an image.

The network cable 120 is an intermediate transmitting a high resolution image signal outputted from the network camera system 110 to the DVR system 140 and may be formed of a general LAN cable, which is commonly used to connect separate LAN networks to each other, connected via Ethernet. For example, unshielded twisted pair (UTP) that is a telephone line may be used as the LAN cable.

The coaxial cable 130 transmits a second analog image signal, made by down-scaling and converting the high resolution image signal photographed by the network camera system 110 into an analog signal, to the DVR system 140.

The DVR system 140 receives the high resolution image signal transmitted from the network camera system 110 via a LAN card 141 connected to the network cable 120, stores the high resolution image signal in a predetermined memory means, receives a low resolution image signal transmitted from the network camera system 110 and displays in real-time the low resolution image signal via a predetermined display means.

A user of the DVR system 140 may view an image displayed in real time via the display means and, in the case the user want to view the image later, the user may view the high resolution image signal stored in the memory means by searching.

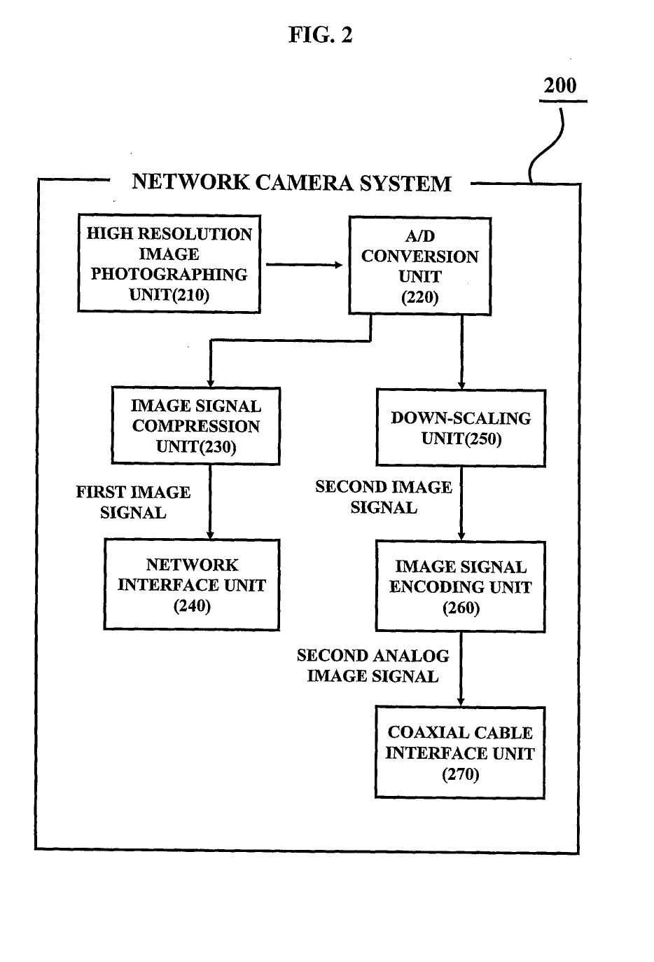

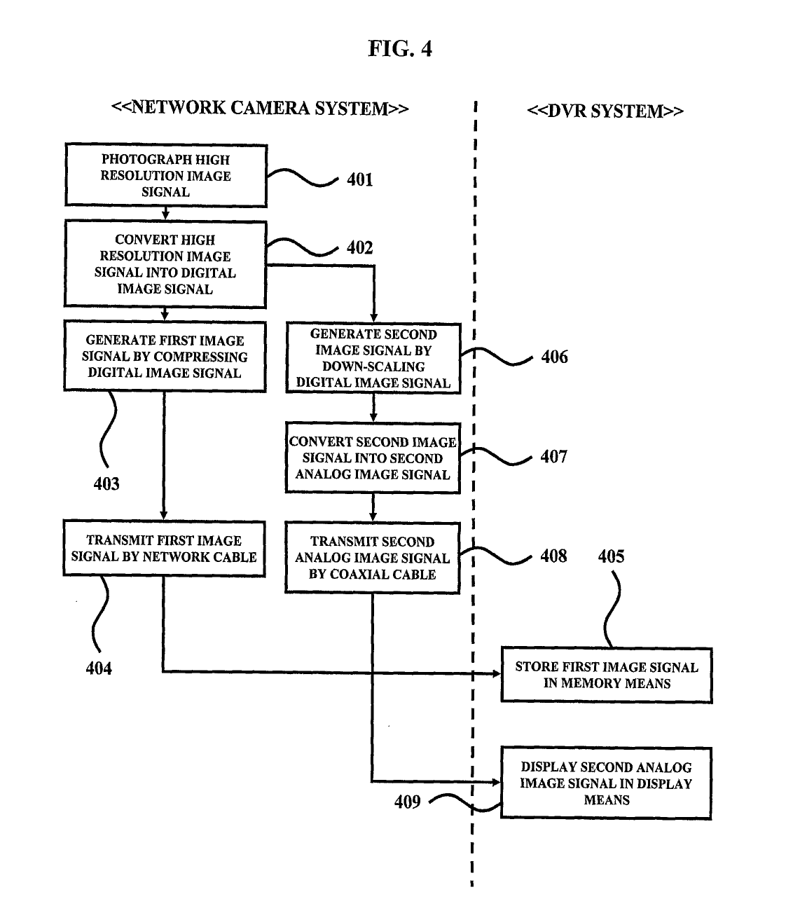

FIG. 2 is a block diagram illustrating a configuration of a network camera system 200 according to an embodiment of the present invention, and FIG. 4 is a flowchart illustrating an image signal transmission method of the network camera according to an embodiment of the present invention. Hereinafter, referring to FIGS. 2 and 4, the image signal transmission method in the network camera system according to the present embodiment will be described.

The network camera system 200 includes a high resolution image photographing unit 210, an A/D conversion unit 220, an image signal compression unit 230, a network interface unit 240, a down-scaling unit 250, an image signal encoding unit 260, and a coaxial cable interface unit 270.

In Step 401, the high resolution image photographing unit 210 photographs an object generating a high resolution image signal. The high resolution image photographing unit 210 is largely formed of a lens and CCD/CMOS image sensor (not shown). Light inputted to the lens is collected and transmitted to an image sensor of the CCD/CMOS, and the CCD/CMOS converts the transmitted light into an electric signal to generate an analog image signal. The high resolution image photographing unit 210 may photograph the object in megapixels such as eight hundred thousand to one million five hundred thousand pixels and may generate the high resolution image signal.

In Step 402, the A/D conversion unit 220 converts the high resolution image signal into a digital image signal.

In Step 403, the image signal compression unit 230 receives the digital image signal from the A/D conversion unit 220 and compresses the digital image signal into a high resolution to generate a first image signal. The network camera system 200 transmits the first image signal that is an image compressed to efficiently transmit the digital image signal, to the DVR system 140. In this case, depending upon a compression method or compressibility, since image quality may not be good in the case the DVR system 140 decompresses to restore the compressed first image signal, the image signal compression unit 230 according to the present embodiment compresses the digital image signal into a high resolution to generate the first image signal, in order to reduce loss of data of the digital image signal.

In Step 404, the network interface unit 240 receives the first image signal from the image signal compression unit 230 and transmits the first image signal to the DVR system 140 connected by network cable. For example, the network cable may be a LAN cable, and the network interface unit 240 may transmit the first image signal to the DVR system 140 located in the LAN network via Ethernet. The network interface unit 240 may be one of RJ-11 formed of a 4PIN connector for telephone, RJ-45 formed of a 8PIN connector for network, used in connecting a LAN card or hub, and DB15 formed of a 15PIN connector for a serial console or a monitor data cable. The first image signal of high resolution, transmitted to the DVR system 140 via the network interface unit 240, is stored in a predetermined memory means of the DVR system 140 (Step 405).

In Step 406, the down-scaling unit 250 receives the digital image signal from the A/D conversion unit 220 and down-scales the digital image signal to a low resolution image signal to generate a second image signal. The digital image signal is “captured by the high resolution image photographing unit 210 and has a resolution in, for example, megapixels. The down-scaling unit 250 may down-scale the high resolution digital image signal into a low resolution image signal similar to a general NTSC/PAL camera, which has a resolution of 640*480 or 768*576, for example, and a low resolution of NTSC/PAL has approximately three hundred thousand to four hundred thousand pixels.

In Step 407, the image signal encoding unit 260 converts the second image signal down-scaled to the low resolution by the down-scaling unit 250 into an analog signal to generate a second analog image signal.

In Step 408, the coaxial cable interface unit 270 receives the second analog signal from the image signal encoding unit 260 and transmits the second analog image signal to a display module, for example, a display card, of the DVR system 140 connected by a coaxial cable. The display module includes a terminal for connecting the coaxial cable interface unit 270 of the DVR system 140 with the coaxial cable.

Since the second analog image signal transmitted to the DVR system 140 via the coaxial cable interface unit 270 is directly displayed in real time via a display means of the DVR system, the user may view an image of an area in which the network camera system 200 is installed and photographs, in real time. The display card of the DVR system 140 enables the transmitted second analog image signal to be directly displayed without an additional process such as decompressing or decoding.

Also, in the case the user recognizes that an unusual situation occurs when the user views the image of the photographed area via the second analog image signal of the low resolution, in order to view the photograph section in detail, the user may search the first image signal stored in the memory means of the DVR system 140, which corresponds to the second analog image signal and compressed into high resolution, to restore.

Namely, according to the present invention, the first analog image signal transmitted from the network camera system 110 is restored without additional decompressing or decoding, thereby reducing a load on the DVR system 140.

Also, in a process of restoring and viewing the first analog image signal, namely, in a process of viewing the low resolution image, in the case the user wants to view a more detailed image, the first image signal corresponding to the first analog image signal is read from the memory means and decompressed and decoded, thereby viewing the high resolution image.

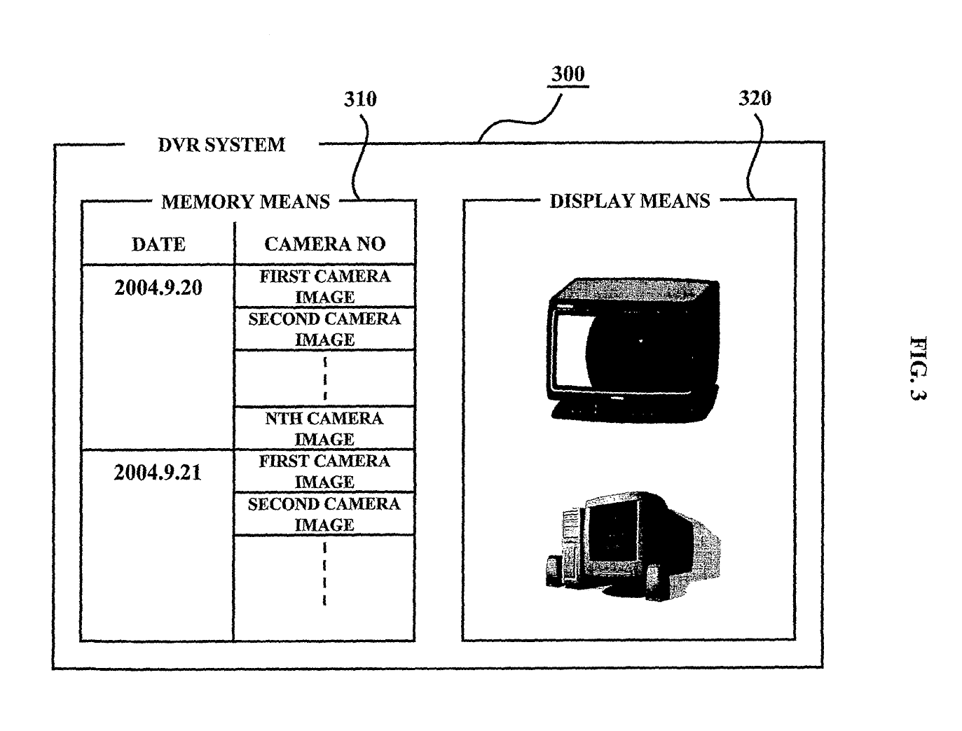

FIG. 3 is a diagram illustrating a configuration of a DVR system 300 connected to the network camera system of the present invention via network. The DVR system 300 is corresponding to the DVR system 140 of FIG. 1.

The DVR system 300 includes a memory means 310 for storing a first image signal and a display means 320 for displaying a second analog image signal in real time.

The memory means 310 stores the first image signal of high resolution, received via the network interface unit of the network camera system. The first image signal may be stored for each category, for example, for each date in which the first image signal is photographed, for each network camera system, or for each area in which each of the network camera system photographs.

The display means 320 displays a second analog image signal received from the coaxial cable interface unit of the network camera system, in real time. Since the second analog image signal is transmitted uncompressed, the second analog image signal may be directly displayed in the display means 320 without additional process such as decompressing or decoding.

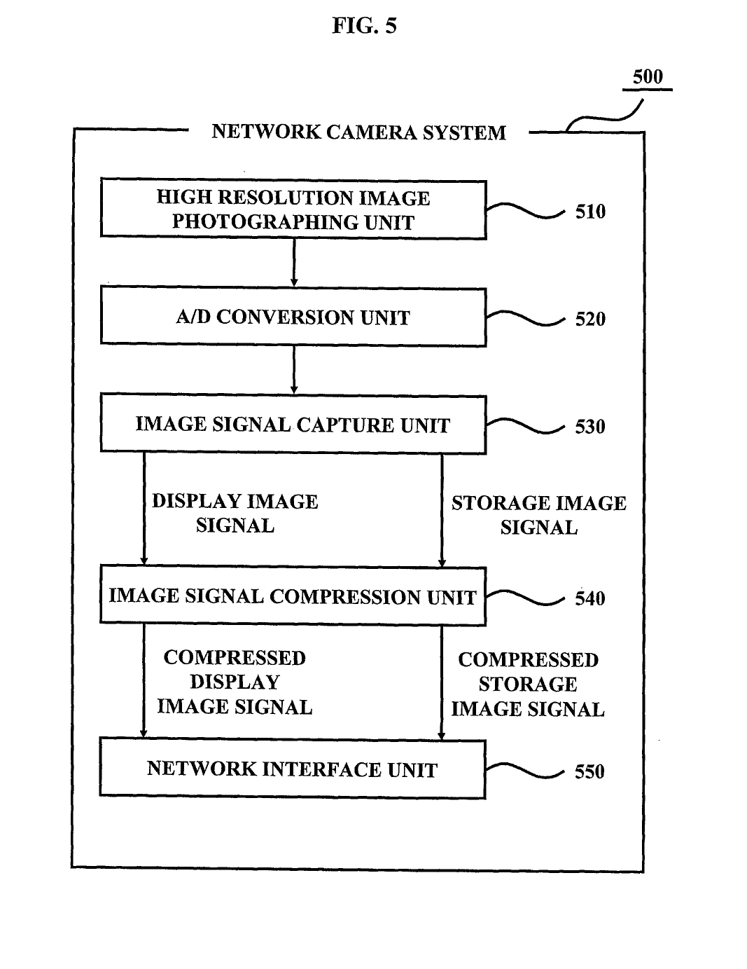

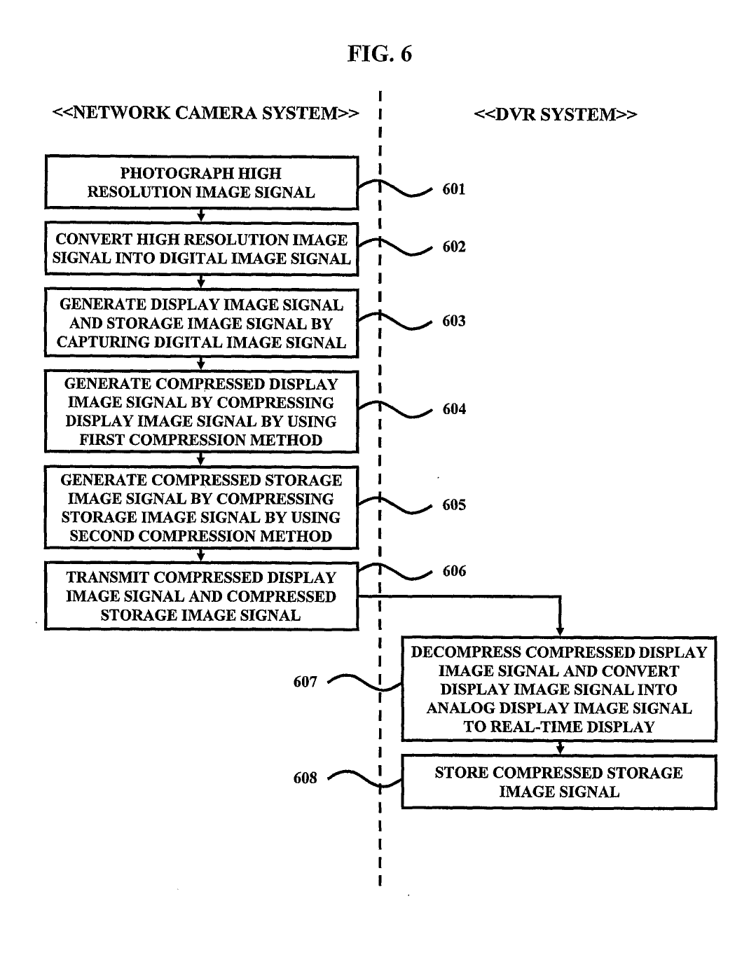

FIG. 5 is a block diagram illustrating a configuration of a network camera system according to another embodiment of the present invention, and FIG. 6 is a flowchart illustrating an image signal transmission method of the network camera according to the present embodiment.

The network camera system 500 according to another embodiment of the present invention largely includes a high resolution image photographing unit 510, an A/D conversion unit 520, an image signal capture unit 530, an image signal compression unit 540, and a network interface unit 550.

In Step 601, the high resolution image photographing unit 510 photographs an object in megapixels, for example, more than eight hundred thousand pixels, to generate a high resolution image signal.

In Step 602, the A/D conversion unit 520 converts the high resolution image signal received from the high resolution image photographing unit 510 into a digital image signal.

In Step 603, the image signal capture unit 530 captures the digital image signal received from the A/D conversion unit 520 and outputs a display image signal and a storage image signal. The display image signal is transmitted to the DVR system 300 to be displayed in real time. The storage image signal is transmitted to the DVR system 300 to be stored. Alternatively, the display image signal and the storage image signal, which are respectively outputted, may be the same signal.

In Step 604, the image signal compression unit 540 compresses the display image signal outputted from the image signal capture unit 530 by a first compression method to a compressed display image signal. In Step 605, the image signal compression unit 540 compresses the storage image signal outputted from the image signal capture unit 530 by a second compression method to output a compressed storage images signal. In this case, the first compression method is for acquiring an image having a quality of low resolution and the second compression method is for acquiring an image having a quality of high resolution. Accordingly, data size of the compressed storage image signal compressed by the first compression method of high resolution is smaller than the compressed display image signal compressed by the second compression method of high resolution.

In Step 606, the network interface unit 550 receives the compressed display image signal and the compressed storage image signal outputted from the image signal compression unit 540, respectively, and transmits the two signals to the DVR system 300 connected by network cable.

The compressed display image signal transmitted to the DVR system 300 via the network interface unit 550 is displayed in a display means 320 of the DVR system 300, via processes of decompression and digitalization (Step 607). The compressed storage image signal is stored in a memory means 310 of the DVR system 300 (Step 608). Different from the described embodiment, since the compressed display image signal is digitalized and compressed, the compressed display image signal may not be directly displayed in the display means and has to be decompressed and converted into an analog signal. However, since the compressed display image has a relatively small data size due to being compressed by the first compression method of low resolution, transmission speed via network is relatively high and resources or time of the DVR system 300, required for decompressing the compressed display image signal is not great, thereby displaying in real time.

Due to the operations of the described configuration of the network camera system 500, the user may view a low resolution display image signal restored by the DVR system 300. Also, in the case the user wants to view more detailed images, for example, in the case the user recognizes an unusual situation while viewing the images, the user may delete the compressed storage image signal stored in the memory means. Accordingly, the DVR system 300 searches the compressed storage image signal stored in the memory means, decompresses and decodes the compressed storage image signal, and outputs the storage image signal via the display means, thereby providing a high resolution image to the user.

Also, the image signal transmission method of the network camera according to the present invention includes a computer readable medium including a program instruction for executing various operations realized by a computer. The computer readable medium may include a program instruction, a data file, and a data structure, separately or cooperatively. The program instructions and the media may be those specially designed and constructed for the purposes of the present invention, or they may be of the kind well known and available to those skilled in the art of computer software arts. Examples of the computer readable media include magnetic media (e.g., hard disks, floppy disks, and magnetic tapes), optical media (e.g., CD-ROMs or DVD), magneto-optical media (e.g., floptical disks), and hardware devices (e.g., ROMs, RAMs, or flash memories, etc.) that are specially configured to store and perform program instructions. The media may also be transmission media such as optical or metallic lines, wave guides, etc. including a carrier wave transmitting signals specifying the program instructions, data structures, etc. Examples of the program instructions include both machine code, such as produced by a compiler, and files containing high-level languages codes that may be executed by the computer using an interpreter. The hardware elements above may be configured to act as one or more software modules for implementing the operations of this invention.

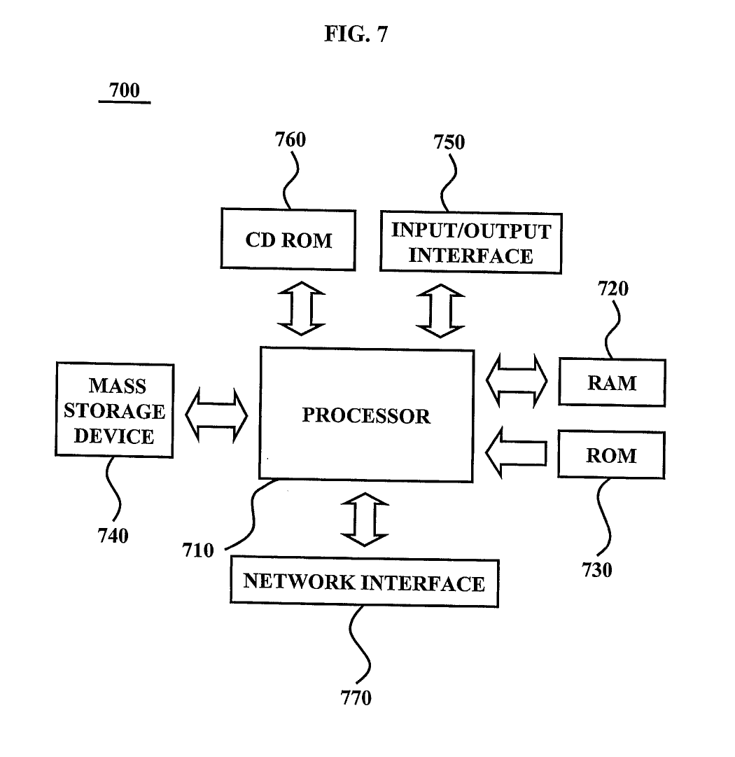

FIG. 7 is an inner block diagram of a general use computer apparatus capable of being applied to perform the image signal transmission method of the network camera according to the present invention.

A computer apparatus 700 includes at least one processor 710 connected to a main memory device including a RAM (Random Access Memory) 720 and a ROM (Read Only Memory) 730. The processor 710 is also called as a central processing unit CPU. As well-known to the field of the art, the ROM 730 unidirectionally transmits data and instructions to the CPU, and the RAM 720 is generally used for bidirectionally transmitting data and instructions. The RAM 720 and the ROM 730 may include a certain proper form of a computer readable recording medium. A mass storage device 740 is bidirectionally connected to the processor 710 to provide additional data storage capacity and may be one of the computer readable recording medium. The mass storage device 740 is used for storing programs and data and is an auxiliary memory. A particular mass storage device such as a CD ROM 760 may be used. The processor 710 is connected to at least one input/output interface 750 such as a video monitor, a track ball, a mouse, a keyboard, a microphone, a touch-screen type display, a card reader, a magnetic or paper tape reader, a voice or hand-writing recognizer, a joy stick, and other known computer input/output unit. The processor 710 may be connected to a wired or wireless communication network via a network interface 770. The procedure of the described method can be performed via the network connection. The described devices and tools are well-known to those skilled in the art of computer hardware and software.

The described hardware devices may be formed to be operated by at least one software module in order to perform the operations of the present invention.

While this invention has been particularly shown and described with reference to preferred embodiments thereof, various changes in form and details may be made therein without departing from the spirit and scope of the invention as defined by the appended claims.

Therefore, the scope of the invention is defined not by the detailed description of the invention but by the appended claims, and all differences within the scope will be construed as being included in the present invention.

### INDUSTRIAL APPLICABILITY

According to the network camera system and the image transmission method of the present invention, a low resolution image signal formed by down-scaling a high resolution image signal captured by a high resolution camera to low resolution is transmitted to a DVR system along with the high resolution image signal, and the DVR system stores the high resolution image signal in a predetermined memory and displays the low resolution image signal in real time, thereby acquiring a high resolution image without overload on the system and network.

Also, according to the network camera system and the image transmission method of the present invention, in a process of compressing a high resolution image signal photographed by a high resolution camera, the high resolution image signal is compressed in two ways into a high resolution storage image signal and a low resolution display image signal and transmitted to a DVR system, and the DVR system stores the high resolution storage image signal in a predetermined memory and displays the low resolution storage image signal in real time, thereby more efficiently acquiring a high resolution image without overload on the system and network.

Also, according to the network camera system and the image transmission method of the present invention, in the case a user recognizes an unusual situation while viewing a low resolution image via a DVR system in real time, a high resolution image that contains the image including the unusual situation may be searched from a memory means of the DVR system and viewed, thereby being possible to efficiently search a high resolution image.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A network camera system comprising:
a high resolution image photographing unit photographing an object and generating a high resolution image signal;
an A/D converter converting the high resolution image signal into a digital image signal;
an image signal compression unit receiving the digital image signals from the A/D conversion unit and generating a first image signal by compressing the digital image signal into a high resolution;
a network interface unit connected to a predetermined network cable, for transmitting the first image signal to a predetermined DVR system connected by the network cable;
a down-scaling unit receiving the digital image signal from the A/D conversion unit and generating a second image signal by down-scaling the digital image signal;
an image signal encoding unit converting the second image signal into an analog signal to be encoded to a second analog image signal; and
an interface unit transmitting the first image signal and the second analog image signal to the DVR system.

2. The system of claim 1, wherein the first image signal is transmitted to the DVR system via the network cable and the second analog image signal is transmitted to the DVR system via a coaxial cable.

3. The system of claim 1, wherein:
the first image signal is transmitted to the DVR system and stored in a memory means of the DVR system; and
the second analog image signal is transmitted to the DVR system and displayed via a display means of the DVR system.

4. A network camera system comprising:
a high resolution image photographing unit photographing an object and generating a high resolution image signal;
an A/D converter converting the high resolution image signal into a digital image signal;
an image signal capture unit generating a display image signal and a storage image signal by capturing the digital image signal;
an image signal compression unit generating a compressed display image signal by compressing the display image signal by using a first compression method and generating a compressed storage image signal by compressing the storage image signal by using a second compression method; and
a network interface unit connected to a predetermined network cable, for transmitting the compressed display image signal and the compressed storage image signal to a predetermined DVR system connected by the network cable,
wherein a data size of the compressed storage image signal is larger than the compressed display image signal.

5. The system of claim 4, wherein:
in the first compression method, the display image signal is compressed to a low resolution image; and
in the second compression method, the storage image signal is compressed to a high resolution image.

6. The system of claim 4, wherein:
the compressed display image signal is transmitted to the DVR system and displayed via a display means of the DVR system, and
the compressed storage image signal is transmitted to the DVR system and stored in a memory means of the DVR system.

7. The system of claim 1, wherein the high resolution image photographing unit generates a high resolution image signal in megapixels.

8. An image signal transmission method of a network camera, comprising the steps of:
generating a high-resolution image signal by photographing an object;
converting the high-resolution image signal into a digital image signal;
generating a first image signal by compressing the digital image signal into a high resolution;
generating a second image signal by down-scaling the digital image signal to a low-resolution image signal;
encoding the second image signal into a second analog image signal;
transmitting the first image signal to a predetermined DVR system connected by network; and
transmitting the second analog image signal to the DVR system connected by a coaxial cable.

9. The method of claim 8, wherein, the operations are performed within the DVR system and comprising the steps of:
receiving the first image signal via the network;
storing the first image signal in a predetermined storage means;
receiving the second analog signal via the coaxial cable; and
displaying the second analog signal via a predetermined display means.

10. An image signal transmission method of a network camera, comprising the steps of:
generating a high-resolution image signal by photographing an object;
converting the high-resolution image signal into a digital image signal;
generating a display image signal by capturing the digital image signal;
generating a storage image signal by capturing the digital image signal;
generating a compressed display image signal by compressing the display image signal in a low resolution;
generating a compressed storage image signal by compressing the storage image signal in a high resolution; and
transmitting the compressed display image signal and the compressed storage image signal to a predetermined DVR system connected by network.

11. The method of claim 10, wherein, the operations are performed within the DVR system and comprising the steps of:
receiving the compressed display image signal and the compressed storage image signal via the network;
decompressing the compressed display image signal and converting the display image signal into an analog display image signal to display via a predetermined display means; and
storing the compressed storage image signal in a predetermined memory means.

12. A computer readable recording medium in which a program for executing the method of claim 8 is recorded.

13. A computer readable recording medium in which a program for executing the method of claim 9 is recorded.

14. A computer readable recording medium in which a program for executing the method of claim 10 is recorded.

15. A computer readable recording medium in which a program for executing the method of claim 11 is recorded.

16. The system of claim 2, wherein the high resolution image photographing unit generates a high resolution image signal in megapixels.

17. The system of claim 3, wherein the high resolution image photographing unit generates a high resolution image signal in megapixels.

18. The system of claim 4, wherein the high resolution image photographing unit generates a high resolution image signal in megapixels.
